(19) United States
(12) Patent Application Publication
(10) Pub. No.: US 2013/0110886 A1
(43) Pub. Date: May 2, 2013

(54) LABORATORY METHOD AND LABORATORY ARRANGEMENT FOR STORING AND CREATING DATA RELATING TO A REMOTE ELECTRICAL POWER DEVICE

(71) Applicant: ABB Technology AG, Zurich (CH)

(72) Inventors: Nicolaie FANTANA, Heidelberg (DE); Oleg KOUZMINE, Dusseldorf (DE); Peter WERLE, Walsrode (DE); Cornelia RADIGK, Halle (DE)

(73) Assignee: ABB Technology AG, Zurich (CH)

(21) Appl. No.: 13/718,386

(22) Filed: Dec. 18, 2012

Related U.S. Application Data
(63) Continuation of application No. PCT/EP2011/003159, filed on Jun. 28, 2011.

(30) Foreign Application Priority Data
Jul. 10, 2010 (EP) 10007132.3

(51) Int. Cl. G06F 17/30

(52) U.S. Cl. CPC G06F 17/30312
USPC 707/812

(57) ABSTRACT

Exemplary embodiments are directed to a laboratory arrangement and method for storing and creating data related to a remote electrical power device. The laboratory arrangement having sampling containers that hold liquid samples from the remote electrical power device, wherein the sampling container has a read/write memory that stores administrative data relating to the sampling and enables unique identification of the liquid sample. The arrangement also includes an input station with a read/write apparatus to read the data in the read/write memory, a sampling container store that stores the sampling containers, and laboratory diagnosis apparatuses that determine present diagnosis data relating to the liquid sample. The present diagnosis data is supplied to a central database, which also stores diagnosis data determined in the past are stored, and an individual analysis system that sets the present diagnosis data and the past diagnosis data in relation to one another.

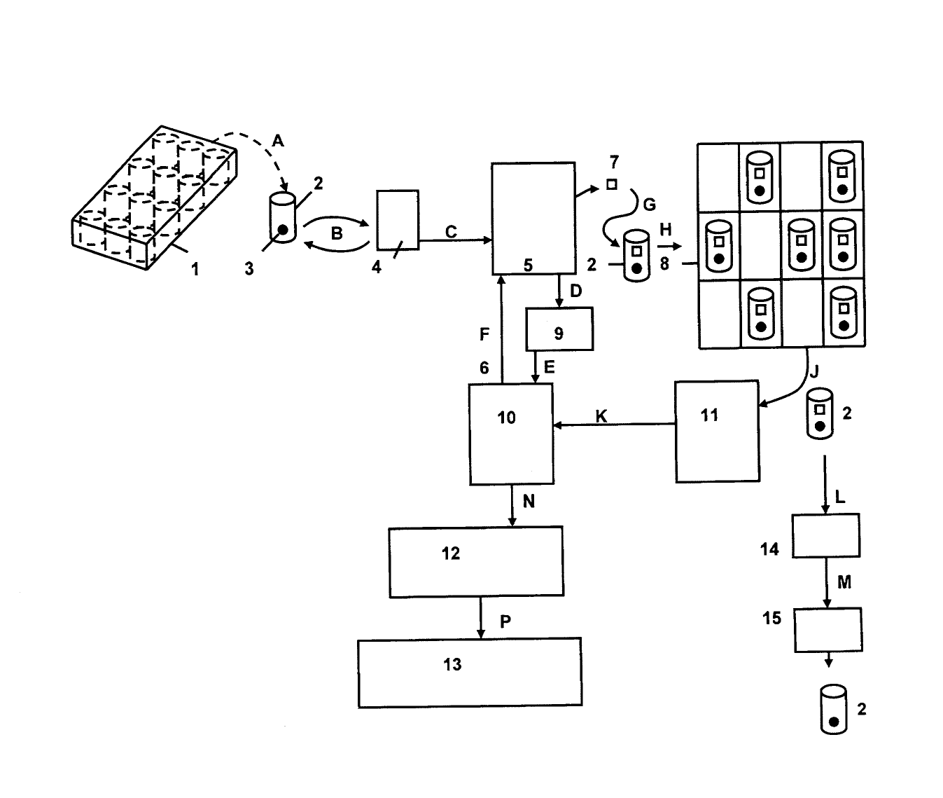

### RELATED APPLICATIONS

This application is a continuation application under 35 U.S.C. §120 to PCT/EP2011/003159, which was filed as an International Application on Jun. 28, 2011 designating the U.S., and which claims priority to European Application 10007132.3 filed in Europe on Jul. 10, 2010. The contents of these applications are hereby incorporated by reference in their entireties.

### FIELD

The disclosure relates to a laboratory method and to a laboratory arrangement for storing and creating data relating to a remote electrical power device.

### BACKGROUND INFORMATION

Known electrical power devices for energy generation and industrial power devices can have cooling liquids or working liquids such as oil. An example of these is an oil-filled power transformer. In order to permanently ensure proper operation of the electrical power device, a liquid sample should be taken from the liquid at specific time intervals. The sampling container filled with the liquid sample is then transported into a remote laboratory, where diagnosis and analysis of the liquid sample can be performed. Bottles formed of aluminum, steel, glass, or plastics can all be used as sampling containers, as well as syringes or containers open at two ends.

In order to retain a precise assignment between the remote electrical power device on the one hand and the liquid sample taken on the other hand, it is known to write down the relevant data, such as owner and identifying data of the remote electrical power device, sampling location and desired analysis values on a sticker or a badge fastened to the sampling container. In this case, there is the risk of the loss of this badge or damage to this sticker. Furthermore, it is known to provide a container with a container tag, which has a read/write region, can be read via radio and enables clear identification of the container.

### SUMMARY

An exemplary laboratory method for storing and creating data relating to a remote electrical power device is disclosed, the method comprising: holding liquid samples from the remote electrical power device in sampling containers; storing administrative data and a unique identification of the liquid sample in a read/write memory of the sampling container; reading the data in the read/write memory using a read/write apparatus of an input station of the laboratory, wherein the data is assigned a predetermined individual laboratory job number, and is supplied to a central laboratory database; storing the sampling containers in a sampling container store; diagnosing one of the liquid samples in a central diagnosis apparatus temporally decoupled therefrom, and supplying present diagnosis data to the central laboratory database; and supplying, from the central laboratory database, the present diagnosis data and past diagnosis data to an individual analysis system, which sets the present and past diagnosis data in relation to one another and processes said present and past diagnosis data in order to obtain an estimate relating to the future operation of the remote electrical power device an estimate relating to the future operation of the remote electrical power device.

An exemplary laboratory arrangement for storing and creating data relating to a remote electrical power device is disclosed, the arrangement comprising: sampling containers that hold liquid samples from the remote electrical power device, wherein the sampling container has a read/write memory, which is suitable for storing administrative data relating to the sampling and enables unique identification of the liquid sample; an input station with a read/write apparatus, to read the administrative data stored in the read/write memory; a sampling container store that stores the sampling containers; laboratory diagnosis apparatuses that determine present diagnosis data relating to the liquid sample; a central laboratory database to which the present diagnosis data are supplied and in which diagnosis data determined in the past are stored; and an individual analysis system that sets the present diagnosis data and the past diagnosis data in relation to one another.

### BRIEF DESCRIPTION OF THE DRAWINGS

The disclosure is described in greater detail below, with reference the following diagram:

The FIGURE illustrates a laboratory method and a laboratory arrangement for storing and creating data in accordance with an exemplary embodiment of the present disclosure.

### DETAILED DESCRIPTION

Exemplary embodiments of the present disclosure specify a laboratory method and a laboratory arrangement for storing and creating data relating to a remote electrical power device.

The laboratory arrangement can perform a method by a laboratory method for storing and creating data relating to a remote electrical power device, wherein sampling containers are used to hold liquid samples from the remote electrical power device, wherein “administrative data” and a unique identification of the liquid sample are stored in a read/write memory of the sampling container, wherein the data in the read/write memory are read by a read/write apparatus of an input station of the laboratory, with assignment of a predetermined individual laboratory job number, and supplied to a central laboratory database, wherein the sampling containers are stored in a sampling container store, wherein a central diagnosis apparatus, temporally decoupled therefrom, implements a diagnosis of the liquid sample taken and supplies the determined “present diagnosis data” to the central laboratory database, wherein the central laboratory database supplies the “present diagnosis data” and the diagnosis data determined in the past to an individual analysis system, which sets the diagnosis data in relation to one another and processes said diagnosis data in order to obtain an estimate relating to the future operation of the remote electrical power device.

According to exemplary embodiments of the present disclosure a laboratory arrangement for storing and creating data relating to a remote electrical power device is disclosed, wherein sampling containers are used to hold liquid samples from the remote electrical power device, wherein the sampling container has a read/write memory, which is suitable at least for storing “administrative data” relating to the sampling and enables unique identification of the liquid sample, wherein the laboratory arrangement has an input station with a read/write apparatus, which serves to read the data in the read/write memory, wherein a sampling container store is provided for keeping the sampling containers, wherein laboratory diagnosis apparatuses are provided which determine “present diagnosis data” relating to the liquid sample, wherein a central laboratory database is provided, to which the “present diagnosis data” are supplied and in which the diagnosis data determined in the past are stored, wherein an individual analysis system is provided, which sets the “present diagnosis data” and the diagnosis data determined in the past in relation to one another.

The central laboratory database can input individually desired order/customer information items to the input station for each sampling container. The analysis system can output recommendations relating to the maintenance of the remote electrical power device and/or recommendations relating to the next sampling. The individual analysis system, for visualizing the results and/or for displaying recommended measures/measures to be implemented, can act on an analysis/display apparatus.

In addition, “ad-hoc sample sensor system data” determined in-situ can be stored in the read/write memory of the sampling container, wherein the “ad-hoc sample sensor system data” are set in relation to the “present diagnosis data”. Correspondingly, the analysis system can output recommendations relating to a specified calibration.

Advantageously, the data in the read/write memory of the sampling container can be overwritten or deleted once they have been read.

The input station can create a label to be stuck onto the sampling container, which label documents the assigned individual laboratory job number. In this case, the label can document the precise storage location of the sampling container within the sampling container store.

Finally, the emptied sampling container can be cleaned and dried.

In an exemplary embodiment, the central laboratory database is physically not itself part of the laboratory arrangement but is connected to the laboratory arrangement via a communication channel.

In another exemplary embodiment, the laboratory can also be implemented in the form of a mobile unit, for example integrated in a motor vehicle.

The advantages which can be achieved by the exemplary embodiments disclosed herein provide for data from a plurality of liquid samples which have been taken from at least one (e.g., a plurality of) remote electrical power device(s) to be input, stored, and processed in a systematic, error-free and time-saving manner in the laboratory, with the result that each of these liquid samples taken can firstly be identified, stored and processed individually, but secondly expedient combination of the individual data relating to the liquid samples with one another is possible in order to thus obtain an overall picture representing the present state of the at least one remote electrical device and in order to be able to propose measures which would enable safe operation of the remote electrical device in the future as well.

The details of the laboratory diagnosis are combined with ad-hoc sample sensor system data determined in-situ, i.e. at the location of the remote electrical device, with already stored “historical data” relating to the remote electrical device and with present comments during the sampling. The combinations and comparisons which can be derived therefrom result in improved diagnosis/analysis and subsequently in an improved prediction in respect of the future operation of the remote electrical power device and in improved decision making in respect of expedient measures, such as calibration and specified checks of the remote electrical device (“in-situ”).

The starting point for the laboratory arrangement and the laboratory method is the use of sampling containers for a liquid with a container tag and preferably with an assigned, detachable ad-hoc sensor unit. A sampling container consisting of aluminum, for example, is used to hold a liquid, in particular oil, for example transformer oil, also referred to below as liquid sample, which sampling container is closed by means of a cap and has a container tag, such as an RFID tag (for example, of the passive type) permanently fitted, for example adhesively bonded, to the outer wall of said container. The cap is optionally provided with an ad-hoc sensor unit, whose communication group protrudes beyond the upper side of the cap.

The container tag has a read-only memory region for storing a unique identification. The container tag also has a read/write memory region, which is suitable for storing the following “administrative data” relating to the sampling installation location and owner of the remote electrical power device, identifying data relating to the remote electrical power device, “historical data” relating to the remote electrical power device, type of liquid, for example type of oil, precise sampling location for the liquid sample, for example “in the base region”, “in the upper region”, “in the central region”, date and time of this sampling, temperature of the liquid sample during sampling, name of the service personnel taking the liquid sample, important (critical) observations or comments of the service personnel while the liquid sample is being taken, the desired analysis values to be determined from the laboratory, for example gases dissolved in the liquid, chemical tests to be implements, furans, etc.

Furthermore, the read/write memory region of the container tag is additionally used for storing desired sensor data determined by means of the ad-hoc sensor unit. In such a case, the memory means of the container tag contain all “ad-hoc sample sensor system data” which are determined in situ during the sampling, relate to the liquid sample, and are important for the laboratory.

Thus, the container tag ensures a unique, unchangeable, and unmistakable designation for the unique identification of the liquid sample. Furthermore, the container tag preferably has a temperature sensor for determining the temperature prevailing during the detection of the desired liquid sample (container temperature).

When using a passive RFID tag as container tag, the container temperature virtually corresponds to the instantaneous temperature at the read time of the liquid sampled and is stored after reading.

When using an active RFID tag as container tag, the sensor data can be detected and stored continuously during the entire sampling operation in the form of a temperature curve (temperature/time dependency). It is then easily possible to derive a temperature of the liquid sample from the temperature curve. Then, the derived temperature is stored.

Instead of an RFID tag, for example, an NFC (near field communication) tag can also be used as container tag.

In the FIGURE, for the purpose of illustrating the proposed laboratory method and the proposed laboratory arrangement for storing and creating data, a laboratory is illustrated schematically to which a charge 1 (a set, a batch) with a large number of sampling containers 2 formed in this way is supplied, wherein each of the sampling containers 2 has a read/write memory 3, which enables a unique identification of each individual sampling container 2. In the laboratory in accordance with a step A, the individual sampling containers 2 are taken successively from the charge 1, wherein, in accordance with a step B, the data in the memory 3 are read individually in each case using a read/write station 4 with assignment of an allocated individual laboratory job number. Optionally, it is then possible to overwrite or delete (unnoticed by the user) specific data, such as the subsequently processed “ad-hoc sample sensor system data”. In accordance with a step C, the read data are fed individually to an input station 5 of the laboratory. This overwriting/ deletion of the data even in the read/write station 4 are advantageous since there is no longer any need for a dedicated apparatus for this.

In an exemplary embodiment the data can be retained first and only a “deletion permissible” data value can be written to the read/write memory 3. A count value of a use counter can also be “raised” to the read/write memory 3 in order to be able to thus track the use of the sampling container 2. This eliminates one method step from the process.

The data to be read are in this case understood to mean, for example, the following “administrative data” data relating to the installation (remote electrical power device): identifying data such as serial number, power, voltage, installation location, owner, type of liquid of the liquid sample (for example type of oil), GPS data relating to the remote electrical power device (the equipment) in which the sampling is performed, precise sampling location for the liquid sample at the equipment (such as, for example, “sampling tap no. xxx”, “base region”, “upper region”, “central region”), sampled quantity, sampling date, acting service personnel (name), date and time of this sampling, the “ad-hoc sample sensor system data” determined by means of the sensor group, user-specific information such as, for example, comments relating to particular events (critical observations) during the sampling operation, the desired analysis values to be created by the laboratory, for example gases dissolved in the liquid, chemical tests to be run, furans, etc. a unique confirmation code generated during the sampling operation with unique assignment to the remote electrical power device and to the time of this sampling, a code for the monitored access.

The data to be read are understood furthermore to be, for example, the following “ad-hoc sample sensor system data” dissolved hydrogen, contained acetylene, contained ethyne, contained water, contained carbon monoxide, contained carbon dioxide, contained oxygen, contained nitrogen, determined conductivity, determined acidity, temperature of liquid sample during sampling. In accordance with a step D, the desired information are taken from the read data taking into consideration the allocated laboratory job number and supplied to a local laboratory data store 9, which, in accordance with a step E, passes on the desired information to a central laboratory database 10. The central laboratory database 10, in accordance with step F, inputs desired order/customer information 6 individually to the input station 5 for each sampling container 2.

The input station 5 of the laboratory has a label printing apparatus, which creates an individual label 7 corresponding to the allocated laboratory job number, the read data and possibly the order/customer information 6, wherein the label 7, in accordance with a step G, is stuck onto the sampling container 2. The sampling containers 2 identified individually in this way can now, in accordance with a step H, be stored in a sampling container store 8 of the laboratory, wherein the precise storage location within the store 8 is expediently predetermined by the input station 5 and noted on the label 7.

In accordance with this preparatory sequence of steps, in a manner temporally decoupled therefrom, the diagnosis of the liquid sample taken can take place in the laboratory. For this purpose, in accordance with a step J, the sampling container 2 is removed from the sampling container store 8 and diagnosis of the liquid sample taken is performed by means of laboratory diagnosis apparatuses 11. The “present diagnosis data” determined during the diagnosis are supplied to the central laboratory database in accordance with a step K. “Present diagnosis data” can be determined as, for example dissolved hydrogen, contained acetylene, contained ethyne, contained water, contained carbon monoxide, contained carbon dioxide, contained oxygen, contained nitrogen, conductivity acidity.

The emptied sampling container 2 is, in accordance with a step L, supplied to a cleaning apparatus 14 of the laboratory and cleaned there. Then, in a step M, drying of the sampling container 2 takes place in a drying apparatus 15. Now, the sampling container 2 is again available for reuse (filling with a liquid sample).

Using the data stored in the central laboratory database 10 and the diagnosis data determined, a desired analysis of the liquid sample taken can now, in accordance with a step N, take place in an individual analysis system 12 of the laboratory taking into consideration the allocated laboratory job number. Depending on the specific result of the analysis performed, in accordance with a step P, a visualization of the result and display of a recommended measure/measure to be implemented is performed with the aid of an analysis/display apparatus 13.

It is important here that all of the diagnosis data already determined in the past and the further data relating to the remote electrical power device are stored in the central laboratory database 10. In this way, it is possible for the “present diagnosis data” to be compared with the diagnosis data determined in the past. These present and historical diagnosis data can be brought into relation with one another, processed, and displayed (visualized) and in this way trends can be identified in good time, with risk estimates, fuzzy logic, neural networks etc., possibly being used. Corresponding to the result of the analysis, the following decisions/recommendations A), B), C), D), E) can be displayed in the analysis/display apparatus 13 taking into consideration the allocated laboratory job number:

A) Decision relating to the future operation of the remote electrical device, such as, for example either “continue operation” or “cease operation immediately” or continue “operation on reduced load”.

B) Recommendation relating to the maintenance of the remote electrical device for example “oil drying necessary in six months” “oil change required”.

C) Recommendation relating to the next sampling for example the normally provided interval needs to be shortened when the values of predetermined indicators (for example dissolved gases) exceed predetermined limit values.

D) Recommendation relating to calibrations to be performed for example as a result of an automated comparison of the “ad-hoc sample sensor system data” with the “present diagnosis data” in the central laboratory database 10. Such an automated comparison is recommended in the case of a dissolved gas (H₂, CO, CO₂, C₂H₂) and/or physical/chemical properties (water content, conductivity, acidity, pH value). A tolerance value of 5 . . . 10%, for example, can be predetermined for the comparison between “ad-hoc sample sensor system data” and “present diagnosis data”. A calibration quality indicator can be formed in order to decide whether the “ad-hoc sample sensor system data” can be taken into consideration in the diagnosis or not, whether a calibration is specified, and whether the ad-hoc sensor unit needs to be taken out of operation.

E) Tracking relating to an effected change in location of the remote electrical device taking into consideration the special conditions for the location.

It is also necessary to track that the central laboratory database 10, for example in the case of the embodiment of the laboratory as a mobile unit, is expediently not physically contained in the mobile unit itself, but is linked via a communication channel, such as a radio link or the Internet, for example. It is sufficient here to enable access to a subset of the total data stock of the central laboratory database 10. This subset contains the elemental data relating to the specific remote electrical power device.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Charge (set, batch) with a large number of sampling containers
2 Sampling container
3 Read/write memory of a sampling container with unique identification
4 Read/write apparatus
5 Input station including label printing apparatus
6 Job/customer information
7 Label
8 Sampling container store
9 Local laboratory data memory
10 Central laboratory database
11 Laboratory diagnosis apparatuses
12 Individual analysis system
13 Analysis/display apparatus
14 Cleaning apparatus
15 Drying apparatus

What is claimed is:

1. A laboratory method for storing and creating data relating to a remote electrical power device, comprising:
holding liquid samples from the remote electrical power device in sampling containers;
storing administrative data and a unique identification of the liquid sample in a read/write memory of the sampling container;
reading the data in the read/write memory using a read/write apparatus of an input station of the laboratory, wherein the data is assigned a predetermined individual laboratory job number, and is supplied to a central laboratory database;
storing the sampling containers in a sampling container store;
diagnosing one of the liquid samples in a central diagnosis apparatus temporally decoupled therefrom, and supplying present diagnosis data to the central laboratory database; and
supplying, from the central laboratory database, the present diagnosis data and past diagnosis data to an individual analysis system, which sets the present and past diagnosis data in relation to one another and processes said present and past diagnosis data in order to obtain an estimate relating to the future operation of the remote electrical power device.

2. The laboratory method as claimed in claim 1, comprising:
wherein inputting, from the central laboratory database individually desired order/customer information items to the input station for each sampling container.

3. The laboratory method as claimed in claim 1, comprising:
wherein outputting, from the analysis system, recommendations relating to the maintenance of the remote electrical power device.

4. The laboratory method as claimed in claim 1, comprising:
outputting, from the analysis system, recommendations relating to the next sampling.

5. The laboratory method as claimed in claim 1, comprising:
storing ad-hoc sample sensor system data determined in-situ in the read/write memory of the sampling container, wherein the ad-hoc sample sensor system data are set in relation to the present diagnosis data.

6. The laboratory method as claimed in claim 5, comprising:
outputting the analysis system recommendations relating to a specified calibration.

7. The laboratory method as claimed in claim 1, comprising:
overwriting or deleting the data in the read/write memory of the sampling container once they have been read.

8. The laboratory method as claimed in claim 1, comprising:
creating, in the input station, a label to be stuck onto the sampling container, which label documents the assigned individual laboratory job number.

9. The laboratory method as claimed in claim 8, wherein the label documents the precise storage location of the sampling container within the sampling container store.

10. The laboratory method as claimed in claim 1, comprising:
cleaning and drying the emptied sampling container.

11. A laboratory arrangement for storing and creating data relating to a remote electrical power device, comprising:
sampling containers that hold liquid samples from the remote electrical power device, wherein the sampling container has a read/write memory, which is suitable for storing administrative data relating to the sampling and enables unique identification of the liquid sample;
an input station with a read/write apparatus, to read the administrative data stored in the read/write memory;
a sampling container store that stores the sampling containers;
laboratory diagnosis apparatuses that determine present diagnosis data relating to the liquid sample;
a central laboratory database to which the present diagnosis data are supplied and in which diagnosis data determined in the past are stored; and
an individual analysis system that sets the present diagnosis data and the past diagnosis data in relation to one another.

12. The laboratory arrangement as claimed in claim 11, wherein the individual analysis system, for visualizing the results and/or for displaying recommended measures/measures to be implemented, acts on an analysis/display apparatus.

13. The laboratory arrangement as claimed in claim 11, wherein the emptied sampling container is supplied first to a cleaning apparatus in the laboratory and then to a drying apparatus.

14. The laboratory arrangement as claimed in claim 11, wherein the central laboratory database is remote from the laboratory arrangement and is connected to the laboratory arrangement via a communication channel.
